(19) United States
(12) Patent Application Publication
(10) Pub. No.: US 2011/0020188 A1
(43) Pub. Date: Jan. 27, 2011

(54) IGCC WITH CONSTANT PRESSURE SULFUR REMOVAL SYSTEM FOR CARBON CAPTURE WITH CO2 SELECTIVE MEMBRANES

(75) Inventors: Mahendhra Muthuramalingam, Chennai (IN); Ashok Kumar Anand, Schenectady, NY (US); Anthony Yu-Chung Ku, Rexford, NY (US); Chetan Madhav Joshi, Thane (IN); Joseph J., Chennai (IN)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/508,808

(22) Filed: Jul. 24, 2009

(51) Int. Cl. B01D 50/00; B01D 53/22

(52) U.S. Cl. 422/169; 96/9; 95/49

(57) ABSTRACT

An integrated gasification combined cycle (IGCC) system involving CO₂ capture is provided comprising a CO₂-selective membrane, a pre-compressor, and a sulfur gas removal system to selectively remove H₂S and CO₂ from shifted syngas, wherein the pre-compressor increases the permeate stream from the CO₂-selective membrane from a first pressure to a second pressure prior to entering the sulfur removal system. Also provided herein is a method of maintaining a substantially constant pressure in a sulfur removal system, comprising introducing a feed gas stream to a CO₂-selective membrane for separation into a syngas rich stream and a permeate gas stream, wherein the permeate gas stream is at a first pressure; increasing the permeate gas stream from the first pressure to a second pressure; and introducing the permeate gas stream at the second pressure to a sulfur removal system downstream of the pre-compressor.

### BACKGROUND

Carbon Dioxide emitted from power plants is considered to be a greenhouse gas that needs to be removed and sequestered. In existing Integrated Gasification Combined Cycle (IGCC) technology, pre-combustion capture of CO₂ is preferred. FIG. 1 depicts a Block Flow Diagram of a typical IGCC system involving CO₂ capture based on existing technologies, which generally includes at least the following major elements:
A. a gasifier 10 with heat exchange of the Syngas to maximize sensible heat recovery;
B. an air separation unit (ASU) 12 to produce oxygen required for gasification;
C. a catalytic water-gas-shift reactor and low temperature gas cooling section 14 to produce a predominantly H₂—CO₂ rich gas;
D. additional product cleaning, H₂S removal and sulfur recovery in an acid gas removal (AGR) system 16; and
E. power generation using an advanced syngas-fueled gas turbine power cycle 18.

Membranes may be incorporated into these systems to assist with CO₂ removal. To date, however, application of membranes to IGCC applications has been limited to streams which predominantly consist of hydrocarbons. FIG. 2 illustrates an IGCC system incorporating a Hydrogen or CO₂ selective membrane 20 that is practiced in Current Art. Steam, which often is used as a sweeping media in the CO₂ membrane, is taken from either the power block 18 or the Low Temperature Gas Cooling (LTGC) section 14 of the IGCC system. FIG. 3 further illustrates the CO₂ selective membrane 20 while FIG. 4 further illustrates a typical Acid Gas Removal (AGR) system.

In conventional ICCC systems (FIGS. 1 & 4), AGR systems 16 are used to remove sulfur along with CO₂ from the syngas (a mixture of CO, CO₂, H₂, CH₄, N₂, H₂O, and trace elements) to produce a “clean sulfur free fuel” that can be burned in a gas turbine. In the case of membrane-based systems (FIG. 2), “clean sulfur free fuel” is separated from the syngas by the membrane 20 to produce the “clean sulfur free fuel” (the retentate stream) and a permeate stream consisting only of the acid gases (CO₂ and H₂S). A sulfur removal system 19 then is used to separate the H₂S from the acid gas mixture of the permeate stream.

A feed gas 22 downstream of the water gas shift reactor enters one side of the membrane while a sweeping media 24 (e.g., steam) enters the other side of the membrane. As the gas travels between the envelopes, CO₂, H₂S, and other highly permeable compounds permeate into the envelope. Thus, the feed gas 22 is separated into a syngas rich stream 26 which is used as fuel in the gas turbine and a permeate stream 28 rich in CO₂ and H₂S which is further separated in the sulfur removal system 16.

Those skilled in the art will appreciate that the driving force for transport for each gas component through the membrane is a difference in partial pressure on the feed and permeate sides. The partial pressure of each component in a gas stream is the product of the mole fraction of the component and the total pressure. The actual rate of gas transport for each component is the product of the permeability of said component and the partial pressure difference. The selectivity of a membrane refers to the relative permeabilities of different components. For example, a membrane with a CO₂/H₂ selectivity of ten (10) would have a CO₂ permeability ten (10) times greater than its H₂ permeability.

The pressure ratio refers to the ratio of the total pressure of the feed and the permeate. To maximize the flux through a membrane, it is desirable to operate the process with large pressure ratios. However, excessive pressure ratios can lead to mechanical failure of the membrane. A sweep stream can be introduced on the permeate side of the membrane to maintain the low pressure ratios, while also retaining a high partial pressure driving force for gas transport.

Although membrane systems offer numerous advantages over more traditional methods of CO₂ removal (including reduced capital costs, lower operating costs, and operational simplicity and increased reliability), there may be significant performance losses due to the adoption of existing solvent-based sulfur removal configurations. Accordingly, there exists a need to provide a sulfur removal system and CO₂ selective membrane having improved efficiency.

### BRIEF DESCRIPTION

Embodiments of the present invention address the above-described needs by providing an integrated system for CO₂ removal and acid gas removal for an integrated gasification combined cycle (IGCC) and methods for improving the efficiency of IGCC systems comprising the integrated system for CO₂ & sulfur removal.

In one embodiment, an integrated system for CO2 removal and sulfur removal for an integrated gasification combined cycle is provided comprising a CO₂ selective membrane for separating a feed gas into a syngas rich stream and a CO₂ rich permeate gas stream at a first pressure; a pre-compressor downstream of the CO₂ selective membrane for increasing the permeate gas stream from a first pressure to a second pressure higher than the first pressure; and a sulfur removal system downstream of the pre-compressor.

In one embodiment, a method for improving the efficiency of an IGCC system also is provided comprising introducing a feed gas stream to a CO₂ selective membrane for separation into a syngas rich stream and a permeate gas stream, wherein the permeate gas stream is at a first pressure; increasing the permeate gas stream from the first pressure to a second pressure; and introducing the permeate gas stream at the second pressure to a sulfur removal system downstream of the pre-compressor.

In one embodiment, an integrated gasification combined cycle (IGCC) also is provided comprising a high-pressure radiant only gasifier; an air separation unit; a catalytic water-gas-shift reactor and low temperature gas cooling section; a CO₂ selective membrane for separating a feed gas into a syngas rich stream and a permeate gas stream at a first pressure; a pre-compressor downstream of the CO₂ selective membrane for increasing the permeate gas stream from a first pressure to a second pressure higher than the first pressure; a sulfur removal system downstream of the pre-compressor; and an advanced syngas-fueled gas turbine power cycle.

### DRAWINGS

FIG. 1 is a schematic illustration of a prior art ICCC system involving CO₂ capture;

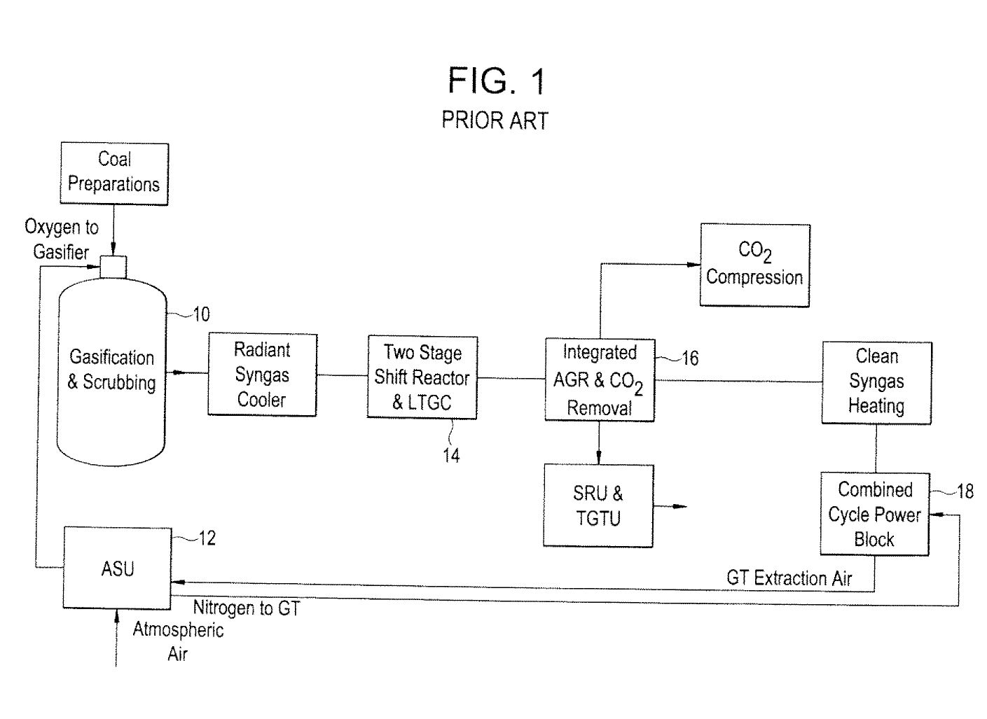

FIG. 2 is a schematic illustration of a prior art IGCC system involving an a CO₂ selective membrane for CO₂ capture;

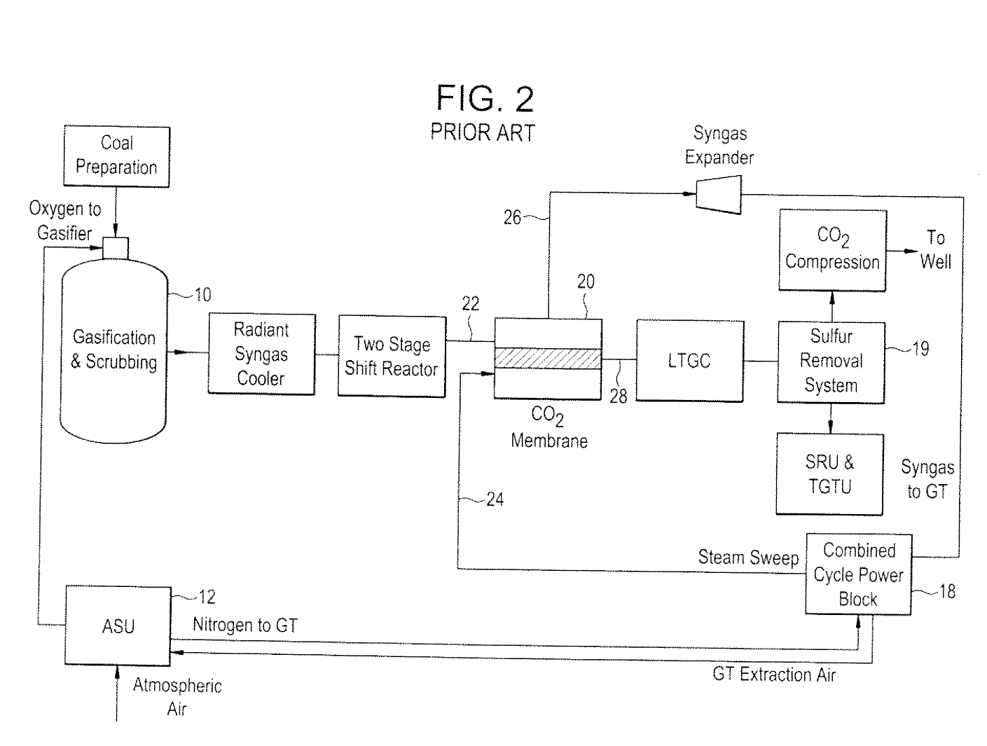

FIG. 3 is a schematic illustration of a prior art CO₂ selective membrane as shown in FIG. 2;

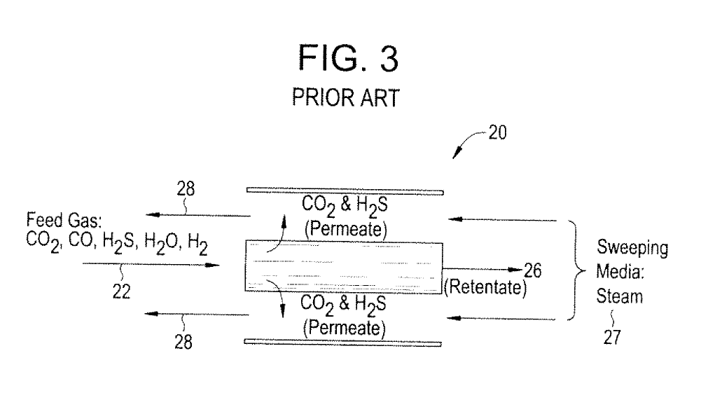

FIG. 4 is a schematic illustration of the sulfur removal system of the prior art as shown in FIG. 2;

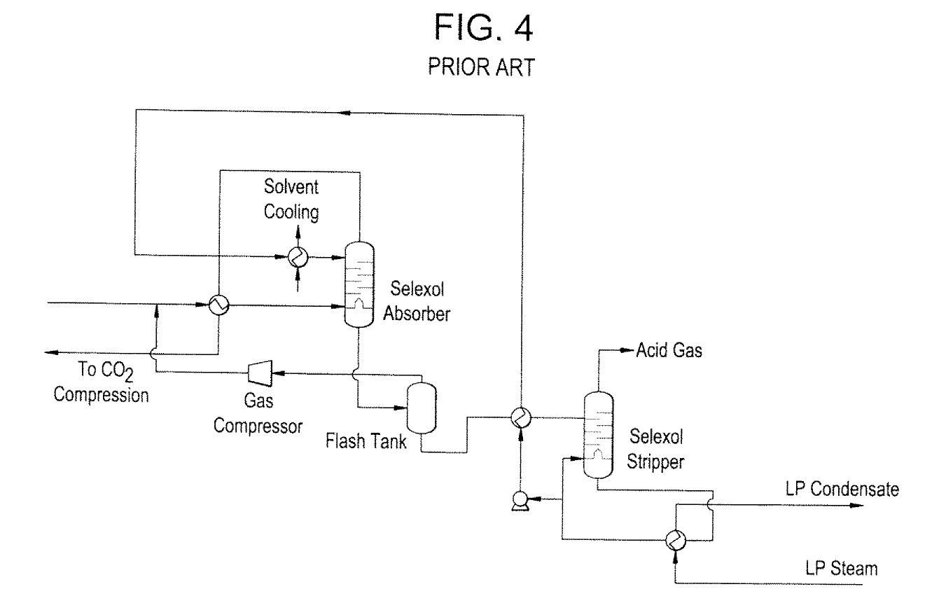

FIG. 5 is a schematic illustration of an IGCC with a CO₂-selective membrane and modified sulfur removal system according to a particular embodiment of the present invention;

FIG. 6 is a schematic illustration of a CO₂ selective membrane and sulfur removal system according to a particular embodiment of the present invention;

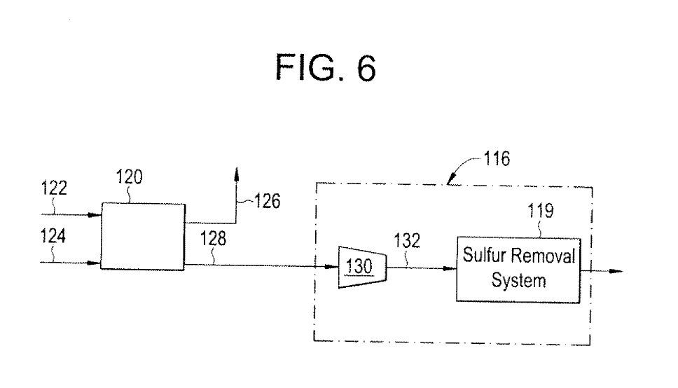

FIG. 7 is a graphical illustration of a sulfur removal system according to a particular embodiment of the present invention;

FIG. 8 is a graphical illustration of the effect of the sulfur removal system pressure on net power according to different scenarios; and

FIG. 9 is a graphical illustration of the effect of the sulfur removal system pressure on steam sweep requirements according to different scenarios.

### DETAILED DESCRIPTION

The efficiency of an IGCC system with CO₂ capture using membranes is reduced due to use of conventional AGR configurations. The key reasons for this performance penalty are due to the lower permeate stream (CO₂ & H₂S) pressure, which drives higher auxiliary loads. Embodiments of the present invention provide system design solutions to help maintain a substantially constant pressure gas stream at the inlet to the sulfur removal system, thereby significantly reducing the re-boiling steam requirement and consequently improving the IGCC system net output and heat rate.

Embodiments of the present invention are based on pre-compression of the permeate gas streams exiting the CO₂ membrane reactor subsequent to the heat recovery from the LTGC. Pre-compression assists in providing a substantially constant pressure at the inlet of the sulfur removal system pressure irrespective of the CO₂ membrane sweep pressure. By increasing the pressure of the permeate, the sulfur removal system performance is improved greatly, driving the cost of such systems lower.

Generally described, the modified IGCC system comprises a gasifier; an air separation unit (ASU); a catalytic water-gas-shift reactor and low temperature gas cooling section; a CO₂ selective membrane; a modified additional product cleaning, H₂S removal and sulfur recovery in a sulfur removal system; and an advanced syngas-fueled gas turbine power cycle.

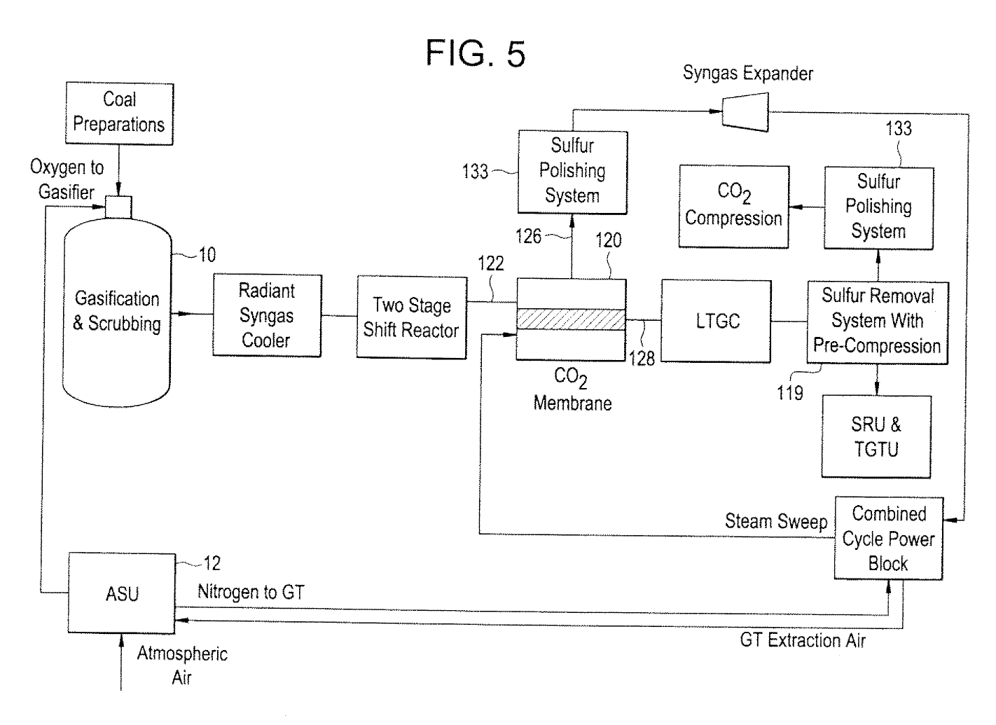

One embodiment of a modified IGCC system is schematically illustrated in FIG. 5. The CO₂ selective membrane 120 separates a feed gas stream 122 into a syngas stream 126 and a permeate stream 128 rich in CO₂ and H₂S using a sweeping stream 124. The permeate stream 128 is at a first pressure prior to entering a pre-compressor 130 and at a second pressure 132 (the sulfur removal system pressure) higher than the first pressure upon exiting the pre-compressor before entering an sulfur removal system 119. The pre-compressor 130 is used to increase the pressure of the permeate gas stream to much higher pressures before entry into the sulfur removal system 119, allowing the sulfur removal system 119 to operate at a higher pressure with a reduced the re-boiling steam requirement that improves performance.

The modified IGCC system (FIGS. 5 & 6) optionally may further comprise one or more polishing modules 133 for removal of traces of H₂S and/or H₂ from the permeate stream downstream of the CO₂ selective membrane and sulfur removal system and upstream from a CO₂ sequestration unit (not shown). The modified IGCC system also optionally may further comprise one or more polishing modules 133 for removal of traces of H₂S from the retentate stream downstream of the CO₂ selective membrane and upstream of the advanced syngas-fueled gas turbine power cycle.

Those of ordinary skill in the art should appreciate that any suitable compressor may be used as the pre-compressor in the embodiments provided herein so long as it is capable of increasing the pressure of the LTGC outlet stream prior to its entry into the sulfur removal system. Non-limiting examples of compressors, which may be suitable include a centrifugal compressor, an axial flow compressor, a reciprocating compressor, or a rotary compressor.

CO₂ selective membranes 120 and sulfur removal systems 119 suitable for use in the embodiments provided herein are known to those of skill in the art. Non-limiting examples of suitable CO₂ selective membranes are described in U.S. Pat. No. 7,396,382 and U.S. Patent Publication No. 2008/0011161 and No. 2008/0127632, the disclosures of which are incorporated herein by reference. Additional non-limiting examples of membranes suitable for use in embodiments include polymeric membranes, such as those disclosed in U.S. Pat. No. 7,011,694. Although these polymeric membranes are limited in temperature, and may also have limitations in operating pressure envelopes, they fall within the scope of the operating temperatures and pressures suitable for embodiments of present invention.

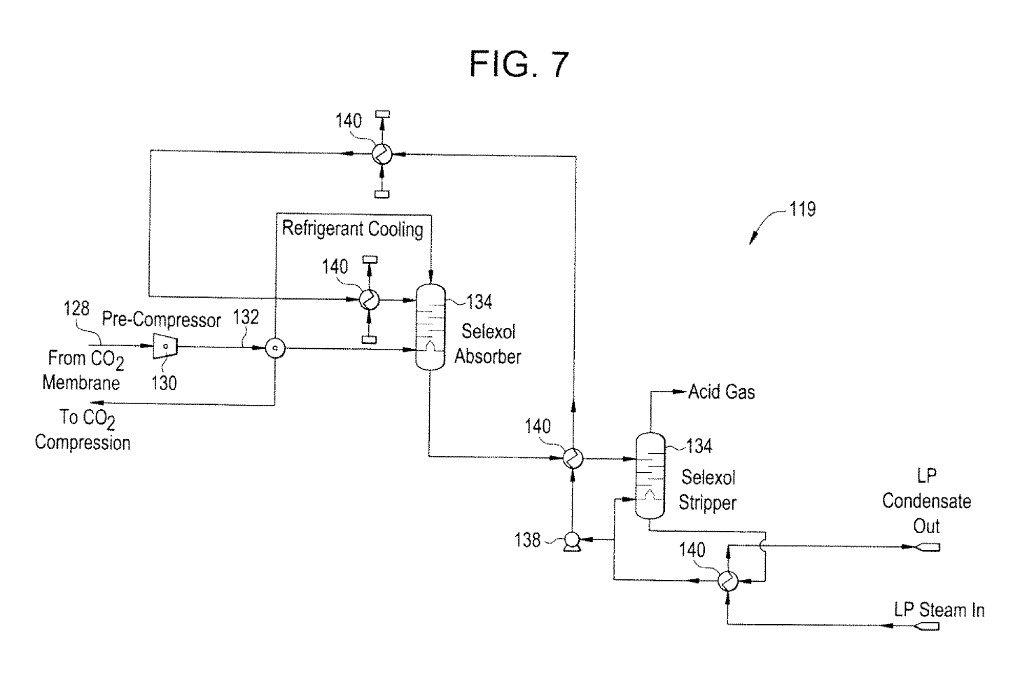

Non-limiting examples of suitable sulfur removal systems are described in U.S. Pat. No. 6,203,599 B1; however, those skilled in the art should appreciate that any suitable sulfur removal system may be used in embodiments provided herein. An exemplary sulfur removal system 119, illustrated in FIG. 7, comprises one or more column(s) 134 for removal of H₂S, and a network of pumps 138 and heat exchangers 140 for controlling the pressure and temperature of the streams while in the system 119. Those of ordinary skill in the art will appreciate that the one or more column(s) for use in the sulfur removal system 119 may comprise any suitable system known to those skilled in the art. For example, in the illustrated exemplary embodiment the one or more column(s) comprise a SELEXOL™ absorber and stripper.

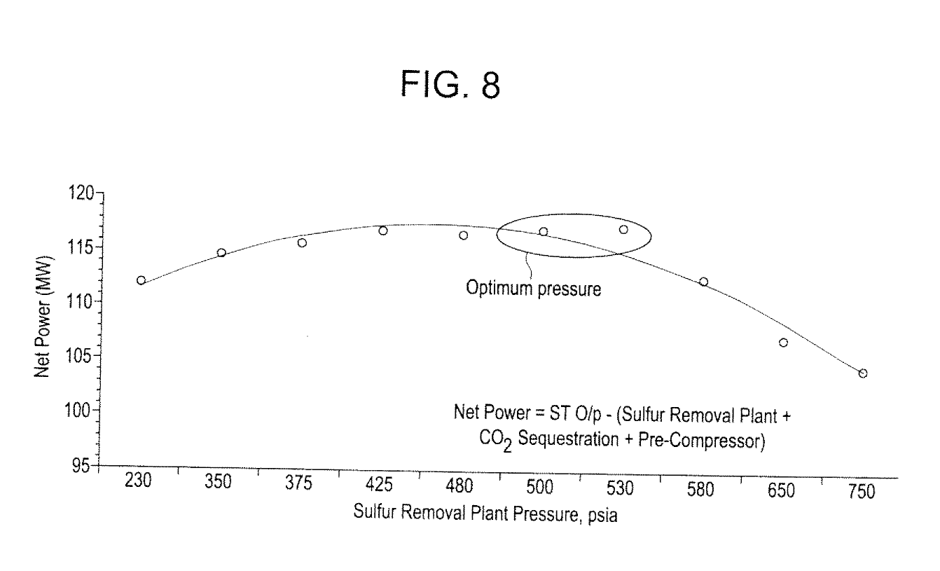

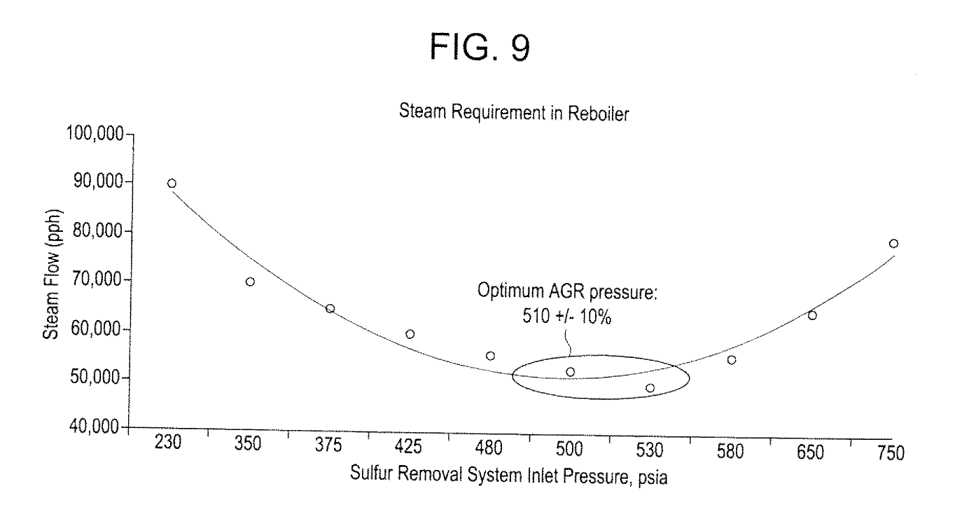

Preliminary calculations were done to explore the potential benefits of the inventions described hereinabove. One calculation evaluated the optimum pressure by identifying the point at which the sulfur removal system pre-compressor power is minimal. The results observed in these simulations are depicted in FIGS. 8 and 9. Specifically, FIG. 8 depicts the net power for different sulfur removal system pressures while FIG. 9 depicts sweep steam requirements for different sulfur removal system pressures. Based on these calculations, it was determined that the pressure of the permeate stream 132 should be increased such that the sulfur removal system operates at a higher pressure which results in a lower auxiliary loads.

Accordingly, in a particular embodiment the pre-compressor increases the pressure of the permeate stream 132 such that the absolute pressure ratio of the second pressure to the first pressure is in the range of about 1.5 to about 20. In other embodiments, the absolute pressure ratio of the second pressure to the first pressure is in the range of about from about 1.5 to about 15, from about 5 to about 10, about 1.5 to about 5, from about 5 to about 10, from about 10 to about 15, or any range therebetween. In one exemplary embodiment, the absolute pressure of permeate stream 132 (second pressure) for operating the sulfur removal system is about 510 psia and the absolute pressure of the permeate stream 128 (first pressure) is about 310 psia for an absolute pressure ratio of 1.6.

The advantages provided by embodiments of the claimed invention can be better explained with the following non-limiting example. An evaluation was conducted using a Hysys Platform to model a sub-system comprising a gasifier, radiant syngas cooler, air separation plant, low temperature gas clean-up system, syn-gas saturation and heating, acid gas removal and sulfur recovery unit, and CO₂ compression and pumping system. Still another evaluation was conducted using a GateCycle Platform to model a sub-system comprising a bottoming cycle of a Heat Recovery Steam Generator (HRSG) and steam turbine (ST), condenser and balance of plant equipment.

As an exemplary example, an IGCC system with CO₂ selective membrane with a gasifier operating at approximately 650 psig pressure, gasified the coal to generate a syngas containing CO, H₂, N₂, H₂O, CO₂ and H₂S. This gas was processed using catalytic shift reactors to form a gas containing approximately 40% H₂, 3% CO, 30% CO₂ and 25% H₂O. This gas entered the CO₂ selective membrane at a pressure of approximately 580 psia. Steam used as a sweeping media, entered the permeate side of the membrane at a pressure of approximately 310 psia. The partial pressure difference across the membrane allowed for permeation of the CO₂ along with the H₂S.

The retentate stream rich in H₂ and CO was sent to a combustion turbine as a fuel after passing through polishing membrane module. The permeate stream leaving the membrane was cooled in a LTGC (low temperature gas cooling) system and later sent to a sulfur separation system. The stream pressure of about 310 psia required additional auxiliary loads in the sulfur removal system and produced a low pressure CO₂ product stream. However, addition of a pre-compressor to the system for allowed for compression of the permeate stream to a pressure of approximately 530 psia. By increasing the stream pressure to the sulfur removal system 119, the auxiliary loads required in the sulfur removal system were reduced, giving a boost to the plant performance. The separated CO₂ stream was subsequently sent to the CO₂ well at 2200 psia. The advantages observed in the overall plant performance are summarized in Table 1.

TABLE 1

| | | Exemplary |
|---|---|---|
| | | System with CO₂ |
| | | Selective |
| | Prior Art with | Membrane & |
| | CO₂ Selective | Pre-compression |
| Description | Membrane | (% Improvement) |
| IGCC Plant Net Output | Base | 2% |
| IGCC Plant Net Heat rate | Base | 2% |

Still further benefits also are observed by the reduction of equipment size resulting from the increase in sulfur removal system operating pressure, allowing for a cost savings in the total plant cost.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An integrated system for CO₂ removal and acid gas removal for an integrated gasification combined cycle (IGCC) comprising:
a CO₂ selective membrane for separating a feed gas into a syngas rich stream and a CO₂ rich permeate gas stream at a first pressure;
a pre-compressor downstream of the CO₂ selective membrane for increasing the permeate gas stream from a first pressure to a second pressure higher than the first pressure; and
a sulfur removal system downstream of the pre-compressor.

2. The system of claim 1, wherein the feed gas comprises a mixture of CO, CO₂, H₂S, H₂O, and H₂.

3. The system of claim 1, wherein the permeate gas stream comprises CO₂ and H₂S.

4. The system of claim 1, wherein second pressure of the permeate gas stream at an inlet of the sulfur removal system and CO₂ selective membrane is substantially constant.

5. The system of claim 3, wherein the absolute pressure ratio of the second pressure to the first pressure is in the range of about 1.5 to 15.

6. A method for improving the efficiency of an IGCC system comprising:
introducing a feed gas stream to a CO₂ selective membrane for separation into a syngas rich stream and a permeate gas stream, wherein the permeate gas stream is at a first pressure;
increasing the permeate gas stream from the first pressure to a second pressure; and
introducing the permeate gas stream at the second pressure to a sulfur removal system downstream of the pre-compressor.

7. The method of claim 6, wherein increasing the pressure of the permeate gas stream comprises feeding the stream through a compressor.

8. The method of claim 6, wherein the feed gas comprises a mixture of CO, CO₂, H₂S, H₂O, and H₂.

9. The method of claim 6, wherein the permeate gas stream comprises CO₂ and H₂S.

10. The method of claim 6, wherein second pressure of the permeate gas stream at an inlet of the sulfur removal system and CO₂ selective membrane is substantially constant.

11. The system of claim 6, wherein the absolute pressure ratio of the second pressure to the first pressure is in the range of about 2 to 20.

12. An integrated gasification combined cycle (IGCC) comprising:
a high-pressure radiant only gasifier;
an air separation unit;
a catalytic water-gas-shift reactor and low temperature gas cooling section;
a CO₂ selective membrane for separating a feed gas into a syngas rich stream and a permeate gas stream at a first pressure;
a pre-compressor downstream of the CO₂ selective membrane for increasing the permeate gas stream from a first pressure to a second pressure higher than the first pressure;
a sulfur removal system downstream of the pre-compressor; and
an advanced syngas-fueled gas turbine power cycle.

13. The system of claim 12, wherein the second pressure of the permeate gas stream at an inlet of the sulfur removal system and CO₂ selective membrane is substantially constant.

14. The system of claim 12, wherein the absolute pressure ratio of the second pressure to the first pressure is in the range of about 1.5 to 15.

15. The system of claim 12, further comprising a CO₂ sequestration unit downstream of the sulfur removal system.

16. The system of claim 12, further comprising a polishing module downstream of the CO₂ selective membrane and upstream of the gas turbine for removal of traces of H₂S from the retentate stream.

17. The system of claim 12, further comprising a polishing module downstream of the CO₂ selective membrane for removal of traces of H₂S and/or H₂ from the permeate stream.

18. The system of claim 15, further comprising a polishing module downstream of the CO₂ selective membrane and upstream of the CO₂ sequestration unit for removal of traces of H₂S and/or H₂ from the permeate stream.
